(19) United States
(12) Patent Application Publication
(10) Pub. No.: US 2025/0222720 A1
(43) Pub. Date: Jul. 10, 2025

(54) STRAIGHT AXLE AND A REAR DRIVE SYSTEM INCORPORATING THE SAME

(71) Applicant: RB Distribution, Inc., Colmar, PA (US)

(72) Inventors: Katherine Adelia Goodman, Feasterville, PA (US); Steven William Butcher, Collegeville, PA (US); Simon Kaschock Marenda, Philadelphia, PA (US)

(73) Assignee: RB Distribution, Inc., Colmar, PA (US)

(21) Appl. No.: 18/655,424

(22) Filed: May 6, 2024

Related U.S. Application Data
(60) Provisional application No. 63/617,480, filed on Jan. 4, 2024.

(51) Int. Cl. B60B 35/12

(52) U.S. Cl. CPC B60B 35/121

(57) ABSTRACT

A straight axle for a vehicle drive assembly including an elongated shaft having a first free end with a plurality of splines formed thereon and a second free end with an externally threaded section that defines the second free end and a plurality of splines that are formed on the elongated shaft behind the externally threaded section. The plurality of splines at the first free end of the elongated shaft and the plurality of splines at second free end of the elongated shaft are configured to engage with complementary splines on associated drive components, and the externally threaded section is configured to receive a fastener that retains one of the associated drive components on the elongated shaft.

This application claims the benefit of U.S. Provisional Application 63/617,489, which was filed on Jan. 4, 2024 and is incorporated herein by reference as if fully set forth.

### BACKGROUND

Vehicle drive systems vary according to the manufacturer's design of the power source and the arrangement for delivering the power to the wheels. In many truck applications, the rear drive system often has a straight or solid rear axle for power transmission to the rear wheels. This system is common in many heavy-duty and off-road vehicles, for hauling, towing, or general heavy duty use.

In full-float applications, the axle shaft extends within an axle housing to a wheel rotor. A spindle is secured to the axle housing and provides support for the axle and carries load from the axle to the axle housing. The wheel rotor is secured relative to the spindle and rotates with rotation of the shaft. In many applications, the wheel rotor includes a wheel hub which is supported by bearings relative to the spindle and an axle hub connects to the axle and is secured onto the wheel hub. In some applications, the wheel hub and axle hub are formed as a unitary component.

In such full-float assemblies, it is desirable to provide a more robust connection between the wheel rotor and the axle.

### SUMMARY

A straight axle for a drive assembly has a first free end with a plurality of splines, a second free end with an externally threaded section that defines the second free end, and a plurality of splines formed in a position behind the externally threaded section. The plurality of splines at the first free end and the plurality of splines at second free end engage with complementary splines on associated drive components, and the externally threaded section receives a fastener for retaining an associated drive component, such as a wheel hub, on the elongated shaft.

### BRIEF DESCRIPTION OF THE DRAWINGS

FIG. 1 illustrate a drive assembly with a straight axle;

FIG. 2 is a perspective view of an assembled straight axle and wheel hub;

FIG. 3 is an exploded view of the assembly in FIG. 2;

FIG. 4 is a perspective view of an assembled straight axle showing the fastener;

FIG. 5 is an exploded view of the assembly in FIG. 4;

FIG. 6 is a section along the line 6-6 in FIG. 4;

FIG. 7 is an enlarged view of the straight axle to hub connection shown in FIG. 6;

FIG. 8 is a front elevation of the straight axle shown in FIG. 5 and the rear elevation is the mirror image thereof;

FIG. 9 is a top plan view of the straight axle shown in FIG. 5 and the bottom plan view is the mirror image thereof;

FIG. 10 is a left side view of the straight axle shown in FIG. 5; and,

FIG. 11 is a right side straight axle shown in FIG. 5; and,

FIG. 12 illustrates a castle nut fastener; and,

FIG. 13 illustrates a fastener with a locking insert.

### DESCRIPTION

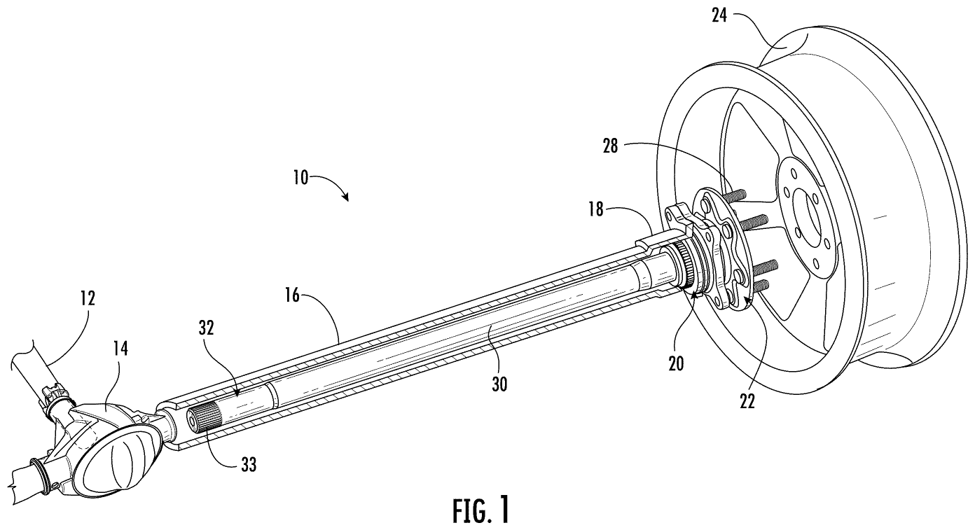

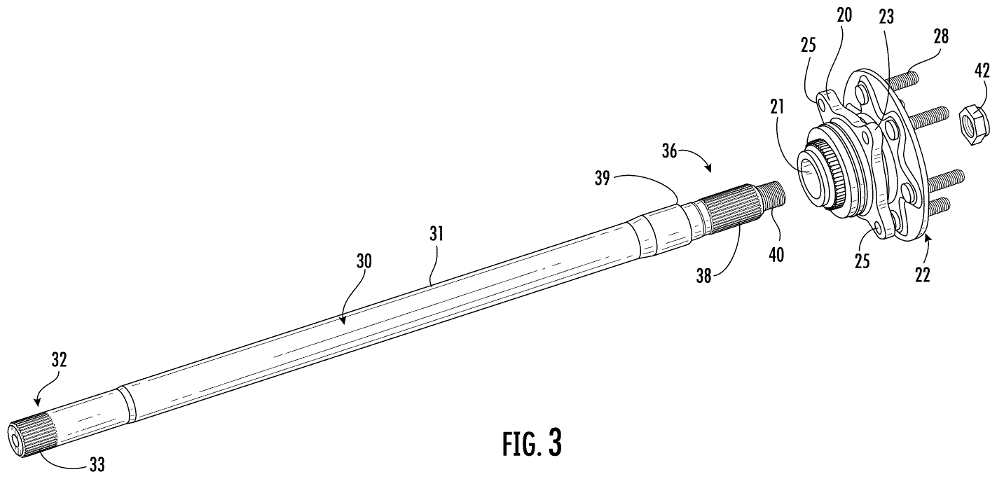

With reference to FIGS. 1-3, the illustrative drive assembly 10 includes a power input source 12 which drives a differential 14 that distributes power to a rear drive axle shaft 30extending within an axle housing 16. By way of example, the differential may have a pinion gear that drives a ring gear. The ring gear in turn drives axle shaft side gears that have internal splines that are configured to mesh with complementary splines on one end of the axle shaft 30. The axle housing 16 is joined to the differential 14 and has a free end 18 configured to accept a spindle 20 in a fixed orientation. The spindle 20 rotatably supports a wheel rotor 22 on which a rim 24 is mounted. This assembly can vary according to the manufacturer and the specific vehicle application; however, the straight axle shaft 30 can be used in those various assemblies.

The straight axle 30 has a linear body 31 extending from a first end 32 to a second end 36. The first end 32 has a plurality of splines 33 that are configured to mesh with complementary splines in a side gear or otherwise within the differential 14.The second end 36 is configured to extend into and through a through passage 21 in the spindle 20 and connect to the wheel rotor 22. The spindle 20 includes a flange 23 extending radially outward and defining a plurality of mounting holes 25 configured to secure the spindle 20 to the axle housing 16. As will be described in more detail hereinafter, the wheel rotor 22 has a plurality of holes for securing lug bolts 28 that secure the rim 24. The number and position of lug bolts 28 is not limited to the embodiment shown and will complement the number and placement of lug bolt holes in the rim 24.

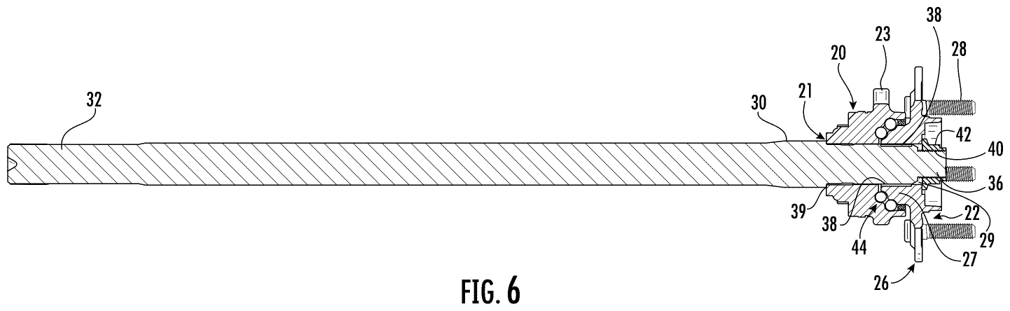

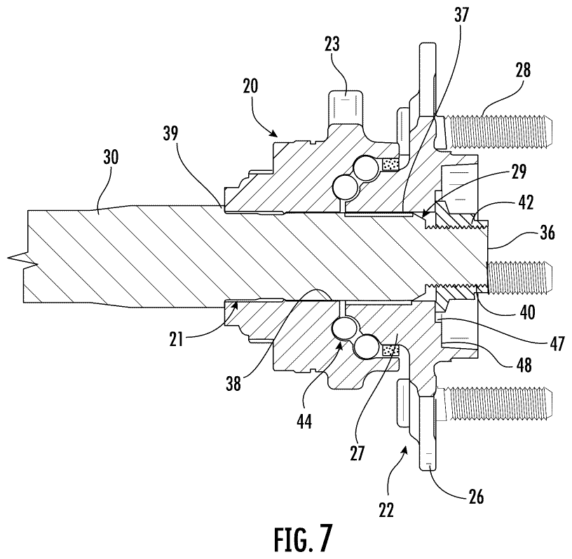

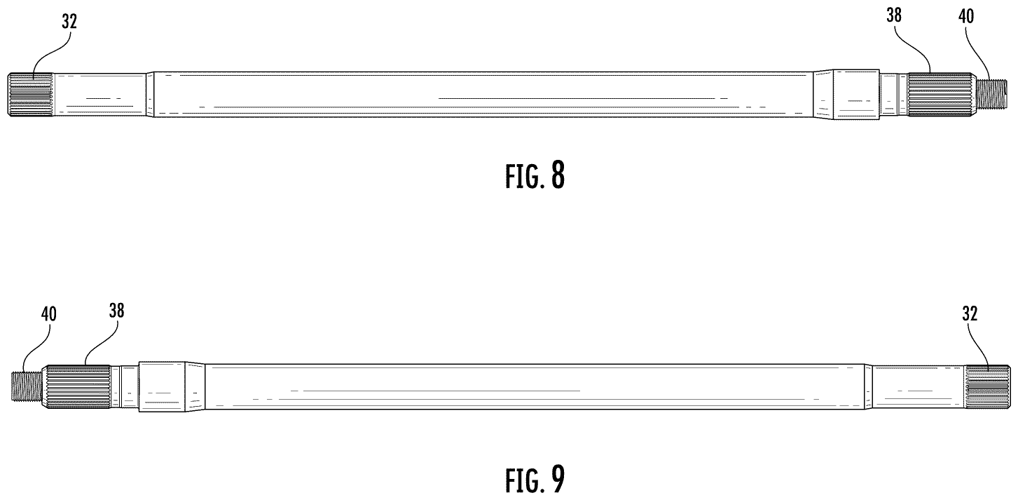

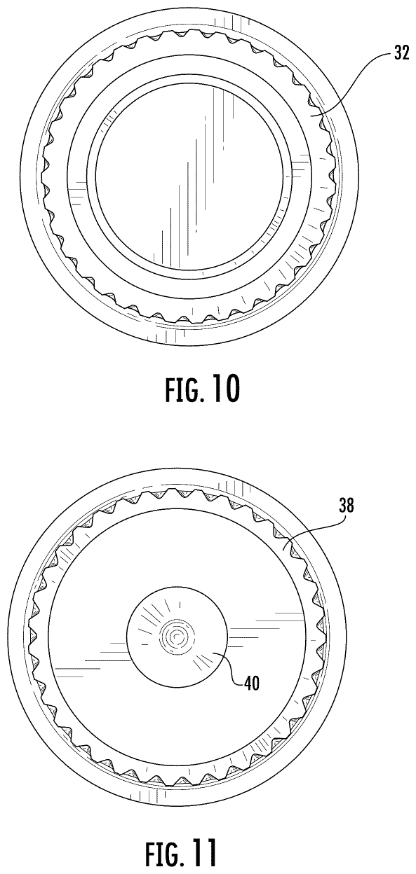

Referring to FIGS. 6 and 7, the wheel rotor 22 of the present embodiment of the disclosure is manufactured with the wheel hub 26 and axle hub 27 as an integral component. However, it is understood that the wheel hub 26 and axle hub 27 may be formed as separate components which are joined or otherwise fastened together. The wheel hub 26 extends radially from the axle hub 27 and defines the plurality of holes for the lug bolts 28. The axle hub 27 has central passage 29 which is axially aligned the spindle through passage 21. In the present embodiment, a bearing assembly 44 is positioned between the spindle 20 and the axle hub 27 such that the wheel rotor 22 rotates relative to the spindle 20. While the illustrated embodiment includes the bearing assembly 44 positioned between the spindle 20 and axle hub 27, it may be otherwise positioned, for example, between the spindle 20 and the wheel hub 26.

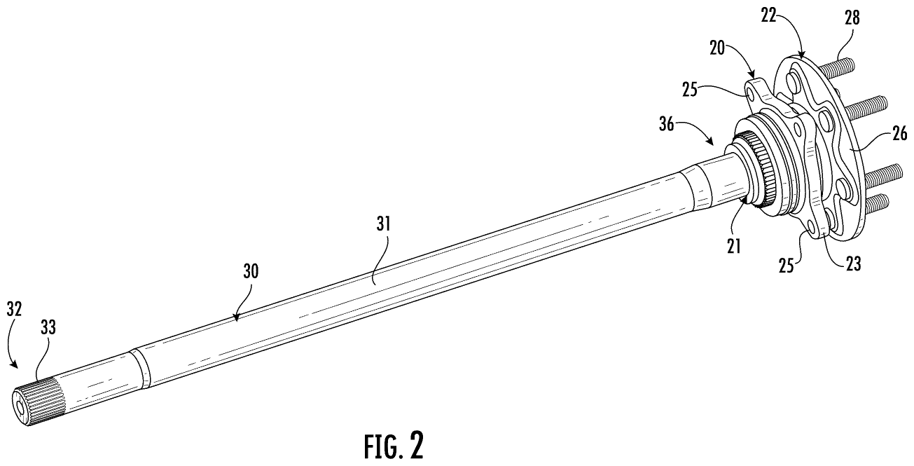

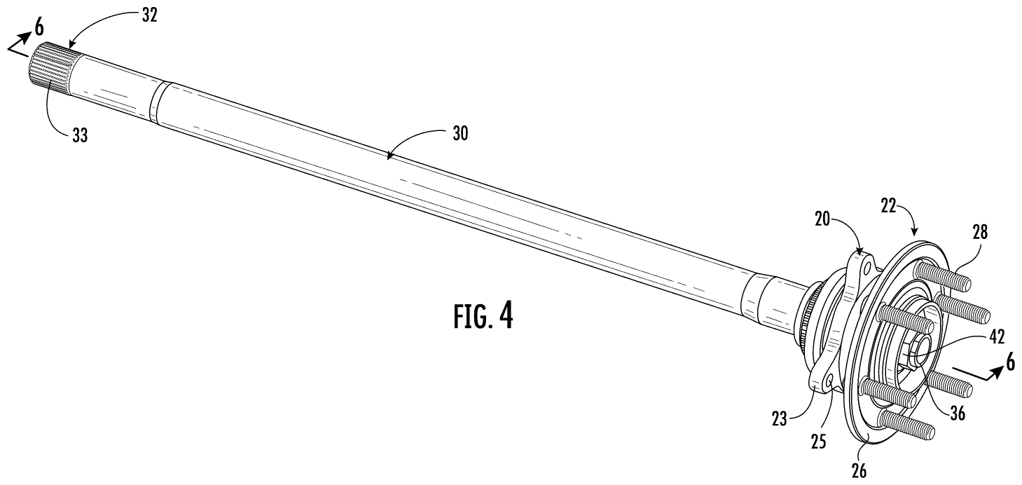

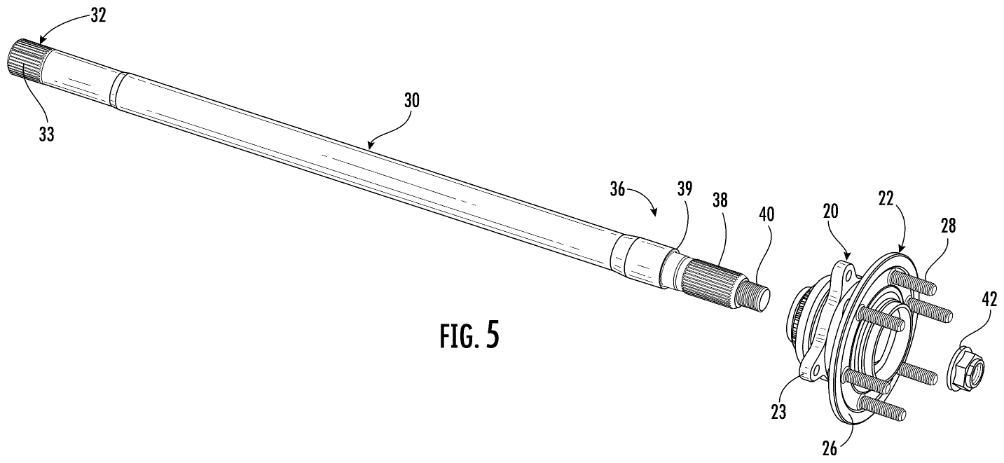

Referring to FIGS. 2-7, the second end 36 of the axle shaft 30 has a threaded end 40 with a plurality of splines 38 that are positioned behind a threaded section 40 of the axle shaft 30. By behind, it is meant that the splines 38 are axially inward to the middle of the axle shaft 30 relative to the threaded end 40. The second end 36 is configured to extend through the through passage 21 and central passage 29 such that at least a portion of the threaded end 40 extends beyond the end face 48 of the axle hub 27. The body 31 of the axle shaft 30 may define a shoulder 39 which acts as stop relative to the spindle 20 to limit axial passage of the axle shaft 30. When so positioned, the splines 38 mesh with complementary splines 37 along the central passage 29 to provide the driving force for the wheel rotor 22. To secure the axle shaft 30 relative to the wheel rotor 22, the threaded section 40 receives a fastener 42. In the illustrated embodiment, the fastener 42 is an internally threaded nut. As seen in FIG. 7, the fastener 42 may sit in a retainer area 47 defined in the end face 48 about the central passage 29. The fastener 42 is tightened such that is engages the end face 48 and securely holds the wheel rotor 22 in contact with the bearing assembly 44 which bears against the fixed spindle 20. The fastener 42 may have a lock and sealing solution applied thereto, for example, LOCTITE® THREADLOCKER. This assembly with a fastener eliminates the need for relying on a press fit between the splines 38 and the wheel rotor 22 for securing the assembly. Additionally, the threaded end 40 has a diameter relatively equal to the diameter of the axle shaft 30, thereby facilitating a large mating force between the threads and the fastener.

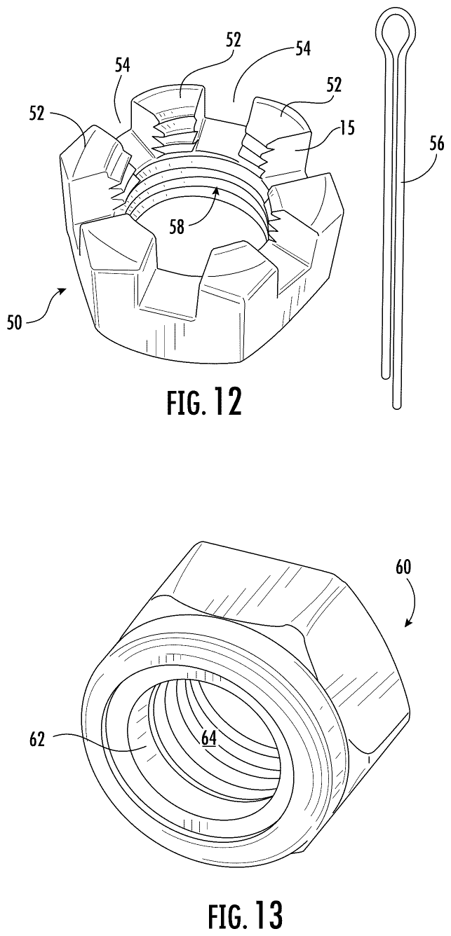

With reference to FIGS. 12 and 13, there are shown some alternatives for securing the fastener 42 on the threaded section 40. The castle nut 50 illustrated in FIG. 12 has a series of raised portions 52 that define slots 54 through which a cotter pin 56 can pass. The internal threads 58 continue through the raised portions 52. In use, the castle nut 50 requires the threaded portion 40 to have a hole through which the cotter pin 56 can be passed and have the ends of the cotter pin 56 spread apart after the castle nut 50 is tightened in place. Such a configuration prevents the castle nut 50 from turning in a loosening direction once the cotter pin 56 is secured.

The nut 60 illustrated in FIG. 13 is an alternative lock nut that includes a locking insert 62 that locks the nut 60 on the threaded portion 42. In the illustrated configuration, the locking insert 62 is a nylon insert that does not have the threads 64 like nut 60 and the interior diameter of the locking insert 62 is selected so that application of the nut 60 on the threaded portion 42 causes the threaded portion 42 to thread the locking insert 62.

What is claimed is:

1. A straight axle for a vehicle drive assembly, the straight axle comprising:
an elongated shaft having a first free end with a plurality of splines formed thereon and a second free end with an externally threaded section that defines the second free end and a plurality of splines that are formed on the elongated shaft behind the externally threaded section;
wherein the plurality of splines at the first free end of the elongated shaft and the plurality of splines at second free end of the elongated shaft are configured to engage with complementary splines on associated drive components, and the externally threaded section is configured to receive a fastener that retains one of the associated drive components on the elongated shaft.

2. The straight axle of claim 1, wherein the plurality of splines at the second free end of the elongated shaft are configured to engage a gear located in a differential.

3. The straight axle of claim 1, wherein the plurality of splines on the elongated shaft behind the externally threaded section are configured to engage a wheel rotor.

4. The straight axle of claim 3, wherein the plurality of splines at the second free end of the elongated shaft are configured to engage a gear located in a differential.

5. The straight axle of claim 4, wherein the wheel rotor includes a plurality of lug bolts for connecting a rim to the wheel rotor.

6. The straight axle of claim 1, wherein the fastener is a castle nut.

7. The straight axle of claim 1, wherein the fastener includes a locking insert.

8. The straight axle of claim 1, wherein the fastener has a lock and sealing solution applied thereto.

9. A vehicle rear drive system comprising:
a rear drive assembly that transmits power to at least one axle shaft;
a wheel rotor; and,
an axle shaft having a first end configured to mate with the rear drive assembly, and a second end configured to mate with the wheel rotor;
wherein the second end of the axle shaft that mates with the wheel rotor includes an externally threaded portion that receives a threaded fastener for retaining the wheel rotor assembly on the axle shaft.

10. The vehicle rear drive system of claim 9, wherein the second end of the axle shaft has a plurality of splines behind the externally threaded portion which mate with a plurality of splines within a central passage of the wheel rotor.

11. The vehicle rear drive system of claim 9, further comprising an axle housing extending from the rear drive assembly about the axle shaft, and
a spindle fixedly supported relative to the axle housing, wherein the wheel rotor is supported by the spindle and configured to rotate about the spindle.

12. The vehicle rear drive system of claim 11, wherein a bearing assembly is positioned between the spindle and the wheel rotor.

13. The vehicle rear drive system of claim 9, wherein the wheel rotor includes a wheel hub which supports a plurality of lug bolts and a wheel axle configured to fixedly engage the axle shaft.

14. The vehicle rear drive system of claim 13, wherein the wheel hub and axle hub are manufactured as a unitary component.

15. A vehicle rear drive system comprising:
a rear drive assembly that transmits power to an axle shaft;
a pair of wheel rotors; and,
a pair of straight axle shafts, each straight axle shaft has a first end configured to mate with the rear drive assembly, and a second end configured to mate with a respective wheel rotor;
wherein the second end of each straight axle shaft that mates with a respective wheel rotor includes an externally threaded portion that receives a threaded fastener for retaining the respective wheel rotor on the respective straight axle shaft.

16. The vehicle rear drive system of claim 15, wherein the second end of each axle shaft has a plurality of splines behind the externally threaded portion which mate with a plurality of splines within a central passage of the wheel rotor.

17. The vehicle rear drive system of claim 15, further comprising an axle housing extending from the rear drive assembly about the axle shaft, and
a spindle fixedly supported relative to the axle housing, wherein the wheel rotor is supported by the spindle and configured to rotate about the spindle.

18. The vehicle rear drive system of claim 17, wherein a bearing assembly is positioned between the spindle and the wheel rotor.

19. The vehicle rear drive system of claim 15, wherein the wheel rotor includes a wheel hub which supports a plurality of lug bolts and a wheel axle configured to fixedly engage the axle shaft.

20. The vehicle rear drive system of claim 19, wherein the wheel hub and axle hub are manufactured as a unitary component.
